(19) United States
(12) Patent Application Publication
(10) Pub. No.: US 2004/0074549 A1
(43) Pub. Date: Apr. 22, 2004

(54) Bore plug

(76) Inventor: John R. Allen, Houston, TX (US)

Correspondence Address: STREETS & STEELE, 13831 NORTHWEST FREEWAY, SUITE 355, HOUSTON, TX, 77040, US

(21) Appl. No.: 10/675,176

(22) Filed: Sep. 30, 2003

Related U.S. Application Data
(60) Provisional application No. 60/419,719, filed on Oct. 18, 2002.

(51) Int. Cl. F16L 55/10; F16L 55/12

(52) U.S. Cl. 138/89; 138/90; 138/93

(57) ABSTRACT

An expandable plug fitted with a pressure valve for plugging a tubular bore having a shaft member with one or more cylindrical cylinders and one or more cylindrical sleeves slideably disposed on the shaft member and a flange is attached near the distal end to retain the cylindrical seals and cylindrical sleeves on the shaft member. The shaft member may be hollow with a pressure valve secured within the hollow shaft. A pulling mechanism disposed at the proximal end of the shaft member compresses the cylindrical seals by exerting an axial force upon the shaft member in a proximal direction, thereby causing the shaft member to slide through the axial openings of the cylindrical seals and the cylindrical sleeves in the proximal direction, thereby compressing the cylindrical seals between the flange and the pulling mechanism. The compressed seals expand radially, sealing the tubular bore.

This application claims the benefit of U.S. Provisional Application No. 60/419,719, filed Oct. 18, 2002.

### BACKGROUND OF THE INVENTION

1. Field of the Invention

This invention relates to fluid handling and more particularly, to an apparatus and method for plugging a tubular bore.

2. Description of the Related Art

After tubing and piping is manufactured, it is often necessary or desirable to protect the interior of the tubing and piping from the outside environment. This may especially be true if threads have been machined into the interior end surfaces of the tubing or piping. Furthermore, after tubing or piping is installed for its intended purpose, it is often necessary to pressure test the system to ensure that all the piping or tubing is properly joined so that there will be no leaks when the system is placed into service. Additionally, it is often desired to maintain a positive pressure on the tubes or piping to prevent corrosion or other damage to the interior of the tubes while they are being stored or shipped or during construction, such as providing an internal gas purge during welding.

The prior art teaches many different types of plugs that have been designed to plug the ends of the tubular bores of pipes and tubing. In U.S. Pat. No. 5,771,937 a device for plugging a pipe includes a resilient, hollow body member that expands with the application of internally applied pressure to block the pipe, much like blowing up a balloon inside of a tubular bore. This system requires a source of compressed air or other gas to inflate the balloon.

In U.S. Pat. No. 5,119,861 a device is disclosed for plugging a pipe that comprises an elastomer seal. The resilient elastomeric seal is attached to the perimeters of two axially aligned rigid end plates. This device relies upon the elasticity of the elastomeric seal to draw the end plates together while radially expanding so as to engage and seal against the inner wall of a tubular bore. This device lacks any means for tightening the seal beyond the force exerted by the elastomer as the elastomer is allowed to relax from a stretched position.

In U.S. Pat. No. 4,968,197 a device is disclosed that includes a disc-like screw plate, an elastic sealing ring, a horn-like pressure block and a lifting eye. The screw plate receives the bottom edge of the sealing ring and the horn-like pressure block is mounted on the upper edge. The screw plate has a central rod that extends upwardly through a hole in the pressure block. The lifting eye is then threaded received on the end of the rod and as the lifting eye is turned, the block and plate are urged together causing the sealing ring to expand against the internal wall of a pipe.

Even with these devices and others that are available for use in plugging tubular bores, problems remain in the art. One problem is that it is difficult to install these devices and then prevent the devices from being “cocked” either before or after installation. If the device is cocked in the tubular bore before a seal is made, these devices will not be capable of sealing the tubular bore because it is impossible to achieve contract all around the tubular bore's interior wall when the sealing device is cocked. Furthermore, when the pipe or tubing is being shipped with an installed plug, if the plug is subjected to an external force during shipping or handling, the plug may become cocked and the seal will be lost.

Another problem with the existing tubular bore plugs is that they provide no means for pressurizing the tubular bore after a plug is installed or for checking whether a tubular bore is under a positive pressure after the tubular bore plug has been installed. Without first installing an additional valve on the tube or pipe, the prior art devices do not provide a means for maintaining a positive pressure within a sealed tubular bore or provide a means for increasing or decreasing the pressure.

Another problem that existing tubular bore plugs cannot solve is installing a bore plug when there is a flow of fluid coming out of the tubing or piping. The prior art bore plugs may be installed properly only when the pipe is completely out of service. What is needed is a tubular bore plug that may be installed when there is a fluid flow in the tubular bore and further provides a means for pressuring or maintaining a positive pressure within the tubular bore after the bore plug has been installed.

### SUMMARY OF THE INVENTION

The present invention provides an apparatus and method for plugging a tubular bore. The apparatus is a compressible plug that comprises a shaft member having one or more cylindrical seals and one or more cylindrical sleeves slideably disposed around the shaft member. The shaft member is an axis that passes axially through the cylindrical sleeves and cylindrical seals. The compressible plug further comprises a flange attached at or near a distal end of the shaft member, wherein the flange retains the sleeves and cylindrical seals on the shaft member. A pulling mechanism is disposed at or near a proximal end of the shaft member. In a preferred embodiment, the compressible plug comprises two or more cylindrical seals that are separated by at least one of the cylindrical sleeves. This arrangement provides a self-aligning bore plug that prevents the plug from being cocked at an angle within the tubular bore, either before or after the seal has been established.

In a preferred embodiment, the shaft member is hollow and the compressible plug further comprises a pressure valve secured within the hollow shaft member at or near the proximal end of the hollow shaft member. The pressure valve may be secured within the hollow shaft by threads. The pressure valve is a pneumatic type valve having a spring loaded seal that may be opened by depressing a plunger pin. A preferred pressure valve is of the type commonly found on a truck or automobile tire.

The shaft member, the cylindrical sleeve and the flange are all preferably made of metal although other materials are acceptable. A preferred metal is brass. Other acceptable metals include aluminum and copper. The shaft member, the cylindrical sleeve and the flange may all be made of the same material or the pieces may be made of different materials.

The cylindrical seals are preferably made of an elastomer, although other materials are acceptable as long as they are resilient and pliable. Neoprene is one preferred material for the cylindrical seals. Other materials suitable for forming the seals include other thermoplastics, natural rubber and synthetic rubber.

The pulling mechanism may be any device that provides a means for placing an axial force on the shaft member in a proximal direction. A preferred pulling mechanism comprises a nut disposed on a threaded outer circumference of the proximal end of the shaft member. The pulling mechanism further comprises a washer disposed adjacent to a distal end of the nut, wherein the washer diameter is greater than a diameter of the tubular bore. The pulling mechanism causes the hollow shaft member to slide axially in the proximal direction within the one or more cylindrical sleeves and the one or more cylindrical seals.

Optionally, a preferred embodiment of the present invention includes one or more compressible sealant holders slideably disposed around the shaft member, wherein at least one end of the compressible sealant holder may be adjacent to one of the one or more cylindrical sleeves. A preferred sealant holder is a spring and a more preferred sealant holder is a wave spring.

A difference in a diameter of the one or more cylindrical sleeves and a diameter of the tubular bore may be between about 0.02 inches and about 0.2 inches. A difference in a diameter of the one or more cylindrical seals and a diameter of the tubular bore is between about 0.02 inches and about 0.2 inches. Preferably, a difference in a diameter of the one or more cylindrical sleeves and a diameter of the tubular bore may be between about 0.03 inches and about 0.13 inches and the difference in a diameter of the one or more cylindrical seals and a diameter of the tubular bore may be between about 0.03 inches and about 0.13 inches.

The present invention also provides a method comprising inserting an expandable plug into a tubular bore, wherein the expandable plug comprises a shaft member, one or more cylindrical seals slideably disposed around the shaft member, one or more cylindrical sleeves slideably disposed around the shaft member and a pulling mechanism secured to the shaft member; compressing the one or more cylindrical seals; and sealing the tubular bore.

The step of compressing the one or more cylindrical seals further comprises tightening a nut disposed on a threaded outer circumference of a proximal end of the shaft member, wherein the pulling mechanism comprises the nut and wherein the pulling mechanism exerts an axial force on the shaft member in the proximal direction to compress the one or more cylindrical seals.

The method further comprises inserting a sealant into a compressible sealant holder, wherein the sealant holder is slideably disposed around the shaft member and is adjacent to one of the one or more cylindrical sleeves; compressing the sealant holder during the step of compressing the one or more cylindrical seals; and expelling the sealant from the sealant holder as the sealant holder compresses. The sealant is preferably an epoxy.

The method further includes provisions for utilizing an inner pressure valve. In an embodiment wherein the shaft member is hollow and a pressure valve is secured within the hollow shaft, the method further comprises opening the pressure valve before compressing the one or more cylindrical seals; and allowing a fluid in the tubular bore to flow through the pressure valve while compressing the one or more cylindrical seals. The pressure within the tubular bore may also be determined by attaching a standard tire pressure gauge to the pressure valve. The method further provides for adding additional fluid through the pressure valve to maintain a desired pressure within the tubular bore.

The present invention further provides a tool for use with the expandable plug disclosed herein. The tool comprises a handle, a first threaded port on a first end of the handle, a pin secured in a center of the threaded port, wherein the pin is parallel to a wall of the first threaded port, and a second port on a second end of the handle, wherein the first threaded port and the second port are in fluid communication

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIGS. 1A-1B are top views of the expandable seal inserted into a tubular bore in the unexpanded and expanded conditions in accordance with the present invention.

FIG. 2 is a sectional view of the expandable seal.

FIG. 3 is an exploded view of the expandable seal.

FIG. 4 is a sectional view of a special tool that may be used to install the expandable seal.

### DETAILED DESCRIPTION

The present invention provides an apparatus and a method for plugging a tubular bore. Optionally, the apparatus and method further provides for maintaining a positive pressure within the tubular bore to prevent corrosion or other damage that may result from exposure of the tubular bore to the outside environment. The apparatus and method further provides for plugging one or more ends of a tubular bore to conduct a pressure test on the tubular bore. A preferred embodiment of the apparatus is an expandable plug fitted with an pressure valve. The expandable plug comprises a hollow shaft member with the pressure valve secured within a proximal end of the hollow shaft. The hollow shaft member provides an axis for the expandable plug having one or more cylindrical cylinders and one or more cylindrical sleeves slideably disposed on the hollow shaft member. A flange attached near the distal end of the hollow shaft member retains the cylindrical seals and cylindrical sleeves on the hollow shaft member. The expandable plug further comprises a pulling mechanism that is disposed at or near the proximal end of the hollow shaft member. The pulling mechanism compresses the cylindrical seals by exerting an axial force upon the hollow shaft member in a proximal direction, thereby causing the hollow shaft member to slide through the axial openings of the cylindrical seals and the cylindrical sleeves in the proximal direction, thereby compressing the cylindrical seals between the flange and the pulling mechanism.

In use, the expandable plug is inserted into a tubular bore. The pulling mechanism compresses the cylindrical seals by applying an axial force to the hollow shaft member while simultaneously preventing the seals and sleeves from being withdrawn from the tubular bore. The axial force causes the hollow shaft member to slide through the cylindrical seals and cylindrical sleeves, and the flange exerts the compressive force on the cylindrical seals between the flange and the pulling mechanism. When the cylindrical seals compress, the cylindrical seals expand radially, thereby creating a seal against the inner wall of the tubular bore.

The hollow shaft member providing an axis for the expandable plug may have any diameter and length suitable for plugging a tubular bore. The hollow shaft member may take any form, but preferably the shaft member is cylindrical. Advantageously, the hollow shaft member with the pressure valve may be a standard valve as used on a truck or automobile tire. The standard valve used on tires includes the valve stem, which is a hollow tube, and the valve core, often called a Schrader valve, which is inserted into the valve stem. These standard valves are available from Schrader-Bridgeport, a Delaware corporation. Furthermore, valves having a standard bore core chamber No. 1 as defined by the Tire and Rim Association, are available in varying lengths, from about 2 inches to about 6 inches, and have a standard ID of about 0.21 inches and a standard OD of about 0.31 inches. Other standard sizes are also available, such as standard bore core chamber No. 2 and standard bore chamber No. 3, also as defined by the Tire and Rim Association. If a particular tubular bore plugging application requires a plug length different than the standard lengths available for tire valves, the standard valve stems may be lengthened or shortened by cutting or by adding additional stem material by means well known to those having ordinary skill in the art

The standard truck and automobile tire valves are often rated for a maximum working pressure of about 300 psig but the spring loaded pressure valves are available for much higher working pressures if required for a particular bore plugging application. The bore plug of the present invention has successfully maintained pressures on tubular bores up to about 1000 psig. In addition to being used for tires, the pneumatic type valves having a spring loaded seal as discussed above are also used conventionally by many other industries, such as the refrigeration and air conditioning industry. The hollow shaft member is preferably made of a metal and more preferably is made of brass, aluminum, copper or a combination thereof.

The flange on the second end of the hollow shaft member may comprise one or more ribs, a plate or other form secured to the hollow shaft member suitable for retaining the cylindrical seals and sleeves on the hollow shaft. Preferably the flange is of the same material as the hollow shaft member and is a metal. More preferably, the flange is made of brass, aluminum, copper or a combination thereof.

The cylindrical seals, through which the hollow shaft member passes as an axis, are made from a resilient pliable material that is suitable for forming a seal when expanded against the inner surface of the tubular bore. Preferably, the cylindrical seals are made of a thermoplastic and more preferably, the cylindrical seals are made of an elastomer. Alternatively, the cylindrical seals may be made of synthetic or natural rubber. Neoprene is a preferred material for the cylindrical seals but other elastomers may be superior for plugging a tubular bore containing corrosive or other difficult to handle materials. Selection of all materials used in the present invention may be made based upon the plugging application as known to those having ordinary skill in the art. An advantage of providing cylindrical seals made of a resilient, pliable material is that a tight seal may be formed even in a tubular bore having imperfections or threads because the seal material fills voids, such as threads or pits, and molds itself around protrusions, such as a tube seam.

The cylindrical sleeves through which the hollow shaft member passes as an axis are preferably made of a metal. More preferably, the sleeves are made from brass, aluminum, copper or a combination thereof. The sleeves may be bushings and are made from a material that is sufficiently strong to transfer compressive forces to the cylindrical seals, thereby making the seals expand against the inner wall of the tubular bore to create the seal. It should be noted that the hollow shaft member, the flange, the pulling mechanism and the cylindrical sleeves may all be made of the same material or individual components may be made of different materials or combinations of materials.

The expandable plug of the present invention may be used to plug cylindrical bores having a wide range of diameters. The diameter of the expandable bore is varied by changing the diameters of the cylindrical seals and cylindrical sleeves. The clearance between the unexpanded plug and the interior walls of the tubular bore is typically less for a small diameter tubular bore than for a large diameter tubular bore because there is less volume of elastomer making up the cylindrical seals in the smaller diameter expandable plug. For example, for tubular bores having an inner diameter (ID) of less than 0.5 inches, a preferred clearance is about 0.0625 inches. For tubular bores having an ID of about 1 inch, a preferred clearance is about 0.125 inches. Generally, the clearance between the sides of the plug and the ID of the tubular bore may be between about 0.02 inches and about 0.2 inches. Preferably, the clearance between the sides of the plug and the ID of the tubular bore may be between about 0.03 inches and about 0.13 inches.

The arrangement and number of the cylindrical seals and the cylindrical sleeves may vary as long as the arrangement provides for the cylindrical seals to be compressed between the pulling mechanism and the flange. In a preferred embodiment, two separate cylindrical seals are used to facilitate uniform circumferential fitting of the expandable plug into the tubular bore. Furthermore, the use of two cylindrical seals helps prevent the expandable plug from becoming cocked at an angle either during or after sealing the tubular bore with the expandable plug. Furthermore, the ability for the bore plug to be self-aligning and to remain aligned within the tubular bore increases with increasing length of the cylindrical seals. In a preferred embodiment, though not required, the cylindrical seal is compressed between two cylindrical sleeves rather than one cylindrical sleeve and the flange.

As noted above, a flange and a pulling mechanism are provided at opposite ends of the hollow shaft member of the compressible plug. As an axial force is exerted by the pulling mechanism upon the hollow shaft member, the resulting compressive forces compress the cylindrical seals causing them to radially expand, thereby creating the seal in the tubular bore. In one preferred embodiment, two cylindrical seals and three cylindrical sleeves are arranged on the hollow shaft member in the following order, starting at the distal end: flange, first sleeve, first seal, second sleeve, second seal, third sleeve, and pulling mechanism. In this arrangement, the first and second sleeves exert compressive forces on the first cylindrical seal and the second and third sleeves exert compressive forces on the second cylindrical seal. Alternatively, the flange may replace one of the sleeves, providing an arrangement as follows: flange, first seal, first sleeve, second seal, second sleeve, and pulling mechanism. As one having ordinary skill in the art will recognize, there are many different arrangements and numbers of cylindrical seals and cylindrical sleeves that may be placed on the hollow shaft member in accordance with the present invention. Optionally, sleeves and seals may also be placed adjacent to each other as long as the compressive forces may be exerted against the seals to force the seals to expand radially.

The pulling mechanism is a device that applies an axial force to the hollow shaft member, thereby causing the hollow shaft member to slide in a proximal direction through the axial openings of the cylindrical seals and cylindrical sleeves through which the hollow shaft member passes. The pulling mechanism further prevents the cylindrical seals and cylindrical sleeves from being pulled from the tubular bore, thereby exerting compressive forces on the cylindrical seals. The pulling mechanism may be a pulley device through which forces exerted on a wire running through the pulley and attached to the hollow shaft member exerts axial forces upon the hollow shaft member. Alternatively, the hollow shaft member may comprise teeth that engage a pawl to form a ratchet mechanism similar to that found in a standard caulking gun.

In one preferred embodiment, the pulling mechanism comprises a nut that is screwed onto a threaded portion of the hollow shaft member and a washer that has a diameter greater than the diameter of the tubular bore. The washer is located adjacent to the nut on a distal end of the nut. To create the seal in the tubular bore, the expandable plug is placed into the tubular bore and the washer is held against the opening of the tubular bore. As the nut is tightened, an axial force is applied to the hollow shaft member causing the hollow shaft member to slide in a proximal direction through the axial openings of the cylindrical seals and cylindrical sleeves, thereby placing the seals in compression between the flange and the washer. As the nut continues to be tightened, greater compressive forces are generated, causing the cylindrical seals to expand radially against the interior wall of the tubular bore, thereby creating a seal. Typically, two to four turns of the nut are sufficient to create enough compressive force on the cylindrical seals to create the seal for the tubular bore. However, for a given application and expandable plug, a fewer number or greater number of turns may be required.

A special tool may be used to hold the washer of the pulling mechanism against the tubular bore opening while tightening the nut. The tool comprises a handle for gripping the tool and a threaded port in the handle. The hollow shaft member is preferably threaded on the outer surface of the proximal end so that the hollow shaft member may be secured in the threaded port of the handle. A stationary pin in the center of the threaded port depresses the plunger pin of the pressure valve located within the hollow shaft member as the hollow shaft member is secured to the handle. Advantageously, if there is a flow of fluid through the tubular bore while the expandable seal is being inserted, the fluid can flow through the open pressure valve and through the handle, thereby venting through a second port on the handle. Optionally, a hose may be connected to the second port to direct the flow away from the user. After the cylindrical seals have radially expanded to create the seal, the special tool may be removed, causing the pressure valve to close as the plunger pin on the pressure valve is released.

To remove the expandable plug from the tubular bore, the procedure may be reversed. The axial force on the hollow shaft member is removed, thereby removing the compressive forces being applied on the cylindrical seals. With the compressive forces removed, the cylindrical seals contract radially so that the expandable plug may be removed from the cylindrical bore. If the expandable seal has been installed for a period long enough for the cylindrical seals to have lost some of their resilience, the force required to pull the expandable plug is increased. Temporary installations of the expandable plugs of the present invention should be replaced after a set period that may be determined by factors dependant on an individual plugging applications, such as temperature, pressure, vibration, expansion, contraction, corrosive conditions and other factors known to those having ordinary skill in the art. Typically, the expandable plugs are not reusable without at least first providing new cylindrical seals but there are tubular bore plugging applications where re-use would be acceptable.

The pressure valve contained within the hollow shaft member of a preferred embodiment provides advantages over conventional tubular bore plugs. The pressure valve allows a positive pressure of air or an inert gas to be achieved within the plugged tubular bore. Because a preferred pressure valve is the readily available tire valve, a conventional tire pressure gauge may be used to easily measure the positive pressure within the tubular bore. If the pressure is too low, compressed air or another gas may be injected through the tire valve to raise the pressure within the sealed tubular bore, thereby protecting the walls of the tubular bore from corrosion or other damage resulting from exposure to the outer environment. Furthermore, the pressure may similarly be checked before removing the plug from the tubular bore, thereby providing increased safety to a user by providing a means to check the pressure and relieve any pressure before the user removes the expandable plug. Alternatively, if monitoring pressure within the tubular bore or injecting additional gas or other fluid is not desired, the expandable plug of the present invention may be practiced without the pressure valve and the hollow shaft member may be replaced with either a solid shaft member or a capped hollow shaft member. The present invention may be practiced in all other aspects that do not involve the internal pressure valve regardless of whether the shaft member is hollow or solid. Therefore, if the functions of the pressure valve are not required, the invention may be practiced without the pressure valve and with a solid or capped shaft member.

Another preferred embodiment of the present invention provides an expandable seal for plugging a tubular bore permanently. In this embodiment, one or more compressible sealant holders are slideably disposed upon the hollow shaft member. In a preferred embodiment, the sealant holder is a coiled spring. More preferred is a sealant holder that is a wave spring because the wave spring provides a higher volume, for a given spring length, between the coils prior to compression. A preferred sealant is a sealing epoxy, readily available in both one and two component forms and well known to those having ordinary skill in the art. Prior to inserting the expandable plug into the tubular bore, the sealing epoxy is packed between the coils of the spring disposed upon the hollow shaft member. Then, as the pulling mechanism exerts axial forces upon the hollow shaft member to compress the cylindrical seals, the spring is also compressed, forcing the sealing epoxy out from between the coils and into the void areas between the expandable plug and the tubular bore. The sealing epoxy is packed into the void areas creating a permanent seal.

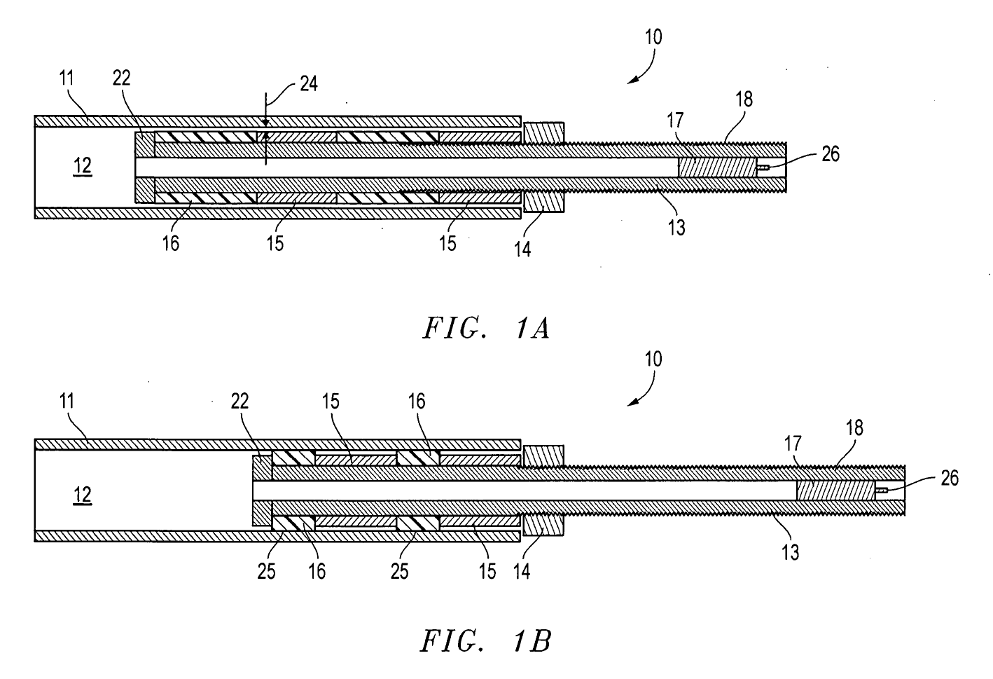

FIGS. 1A-1B are top views of the expandable seal inserted into a tubular bore in the unexpanded and expanded conditions in accordance with the present invention. In FIG. 1-A, a tube 11 is shown with the expandable plug 10 inserted into the tubular bore 12. The expandable plug 10 has not sealed the tubular bore 12 and a clearance 24 is shown between the expandable plug 10 and the inner walls of the tube 11. The cylindrical seals 16 have not been compressed to form a seal. A spring loaded pressure valve 17 is shown within the hollow shaft member 13.

In FIG. 1-B, the expandable plug 10 is shown in the expanded condition thereby plugging the tubular bore 12. By tightening the nut 14, axial force was applied to the hollow shaft member 13, causing the hollow shaft member to slide axially through the cylindrical sleeves 15 and the cylindrical seals 16, further exerting compressive forces upon the cylindrical seals as the flange 22 was pulled towards the nut 14. As the cylindrical seals 16 were compressed, the cylindrical seals 16 expanded radially, creating the seal 25.

If there is a flow of gas through the tubular bore 12 while the expandable plug 10 is being installed, then the pressure valve 17 may be kept open by depressing the plunger pin 26 while the cylindrical seals 16 are being compressed. By allowing gas to flow through the pressure valve 17 during the compression of the cylindrical seals, a good seal may be achieved when there is a flow of gas or other fluid through the tubular bore 12.

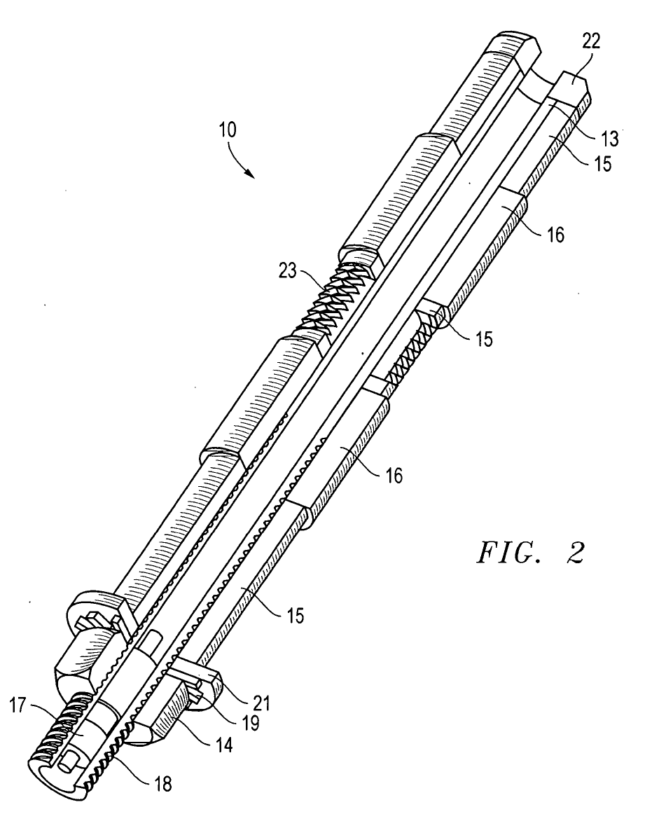

FIG. 2 is a sectional view of the expandable seal. The expandable seal 10 is shown with the hollow shaft member 13 having threads 18 on the proximal end containing the pressure valve 17. A nut 14 provides the means to exert an axial force on the hollow shaft member 13. A lock washer 19 prevents the nut 14 from backing off due to protracted vibration, expansion or contraction after the expandable plug 10 has been installed within a tubular bore. A washer 21 provides a retainer to prevent the sleeves 15 and seals 16 from being pulled out of a tubular bore during compression of the seals 16. The cylindrical seals 16 are compressed between the flange 22 and the washer 21. An optional sealant holder 23 is also shown in the form of a wave spring.

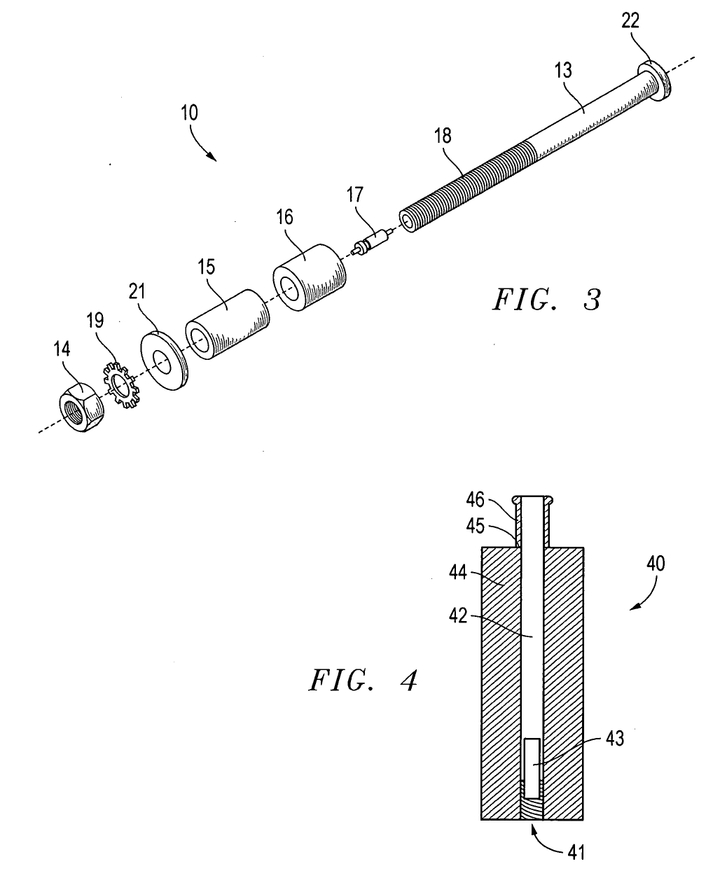

FIG. 3 is an exploded view of an expandable seal. In this embodiment, a different arrangement of the components is shown to illustrate that many different arrangements of the components are possible within the scope of the present invention. The expandable plug 10 is shown with a hollow shaft member 13 having a flange 22 secured to the distal end of the hollow shaft member 13. The proximal end of the hollow shaft member 13 is shown to have threads 18. A pressure valve 17 is disposed within the hollow shaft member 13. The cylindrical seal 16 is compressed between the flange 22 and the cylindrical sleeve 15 when axial force is applied to the hollow shaft member 13 by turning the nut 14 and the washer 21 is held against the opening of the tubular bore 12 (FIG. 1). The lock washer 19 is shown adjacent to a distal end of the nut 14. As an alternative embodiment, the sleeve 15 may be disposed of, creating an expandable seal that creates the compressive forces upon the cylindrical seal with the flange 22 and the washer 21. In that case, the cylindrical seal may be made longer if it is desirable to maintain the same length for the expandable seal. It is preferred, though not required, that the flange 22 have approximately the same diameter as the cylindrical seal 16 whenever the flange 22 directly contacts the cylindrical seal 16 to provide maximum support during the compression of the cylindrical seal 16.

FIG. 4 is a sectional view of a special tool that may be used to install the expandable seal. The special tool 40 comprises a handle 44 having a threaded port 41 in which the threaded portion of the hollow shaft member 13 (FIG. 1-A) may be secured. A pin 43 secured in the center of the threaded port 41 depresses the plunger pin 26 on the pressure valve 17 (FIG. 1-A) when the hollow shaft member 13 is secured to the threaded port 41. A second port 45 is in fluid communication with the threaded port 41 through a bore 42 connecting the threaded port 41 with the second port 45. The second port provides a vent for any fluid that may flow through the opened pressure valve. A connection 46 may be provided for attaching a hose for venting any fluid away from the user.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

1. An apparatus for plugging a tubular bore, comprising:
a shaft member;
one or more cylindrical seals slideably disposed around the shaft member, wherein the shaft member passes axially through the one or more cylindrical seals;
one or more cylindrical sleeves slideably disposed around the shaft member and adjacent to the one or more cylindrical seals;
a flange attached at or near a distal end of the shaft member, wherein the flange retains the cylindrical sleeves and cylindrical seals on the shaft member; and
a pulling mechanism disposed at or near a proximal end of the shaft member.

2. The apparatus of claim 1, wherein the apparatus has two or more cylindrical seals, the cylindrical seals are separated by at least one of the one or more cylindrical sleeves.

3. The apparatus of claim 1, further comprising:
a pressure valve, wherein the shaft member is hollow and wherein the pressure valve is secured within the hollow shaft member at or near the proximal end of the shaft member.

4. The apparatus of claim 3, wherein the pressure valve is secured within the hollow shaft by threads.

5. The apparatus of claim 3, wherein the pressure valve is a pneumatic valve having a spring-loaded seal.

6. The apparatus of claim 1, wherein the shaft member is brass.

7. The apparatus of claim 1, wherein the shaft member is a metal.

8. The apparatus of claim 1, wherein the cylindrical seals are neoprene.

9. The apparatus of claim 1, wherein the cylindrical seals are a material selected from the group comprising an elastomer, rubber and synthetic rubber.

10. The apparatus of claim 1, wherein the cylindrical sleeves and the flange are a material selected from the group comprising brass, aluminum and combinations thereof.

11. The apparatus of claim 1, wherein the cylindrical sleeves and the flange are metal.

12. The apparatus of claim 1, wherein the cylindrical sleeves, the flange and the shaft member are made of different materials.

13. The apparatus of claim 1, wherein the pulling mechanism comprises a nut disposed on a threaded outer circumference of the proximal end of the shaft member.

14. The apparatus of claim 13, wherein the pulling mechanism further comprises a washer disposed adjacent to a distal end of the nut, wherein the washer diameter is greater than a diameter of the tubular bore.

15. The apparatus of claim 1, wherein the pulling mechanism causes the hollow shaft member to slide axially in a proximal direction within the one or more cylindrical sleeves and the one or more cylindrical seals.

16. The apparatus of claim 1, further comprising:
one or more compressible sealant holders slideably disposed around the shaft member.

17. The apparatus of claim 16, wherein at least one end of the compressible sealant holder is adjacent to one of the one or more cylindrical sleeves.

18. The apparatus of claim 16, wherein the compressible sealant holder is a spring.

19. The apparatus of claim 16, wherein the compressible sealant holder is a wave spring.

20. The apparatus of claim 1, wherein a difference in a diameter of the one or more cylindrical sleeves and a diameter of the tubular bore is between about 0.02 inches and about 0.2 inches.

21. The apparatus of claim 1, wherein a difference in a diameter of the one or more cylindrical seals and a diameter of the tubular bore is between about 0.02 inches and about 0.2 inches.

22. The apparatus of claim 1, wherein a difference in a diameter of the one or more cylindrical sleeves and a diameter of the tubular bore is between about 0.03 inches and about 0.13 inches.

23. The apparatus of claim 1, wherein a difference in a diameter of the one or more cylindrical seals and a diameter of the tubular bore is between about 0.03 inches and about 0.13 inches.

24. A method, comprising:
inserting an expandable plug into a tubular bore, wherein the expandable plug comprises a shaft member, one or more cylindrical seals slideably disposed around the shaft member, one or more cylindrical sleeves slideably disposed around the shaft member and a pulling mechanism secured to the shaft member;
compressing the one or more cylindrical seals;
sealing the tubular bore.

25. The method of claim 24, wherein the step of compressing the one or more cylindrical seals further comprises:
tightening a nut disposed on a threaded outer circumference of a proximal end of the shaft member, wherein the pulling mechanism comprises the nut and wherein the pulling mechanism exerts an axial force on the shaft member in a proximal direction to compress the one or more cylindrical seals.

26. The method of claim 24, further comprising:
inserting a sealant into a compressible sealant holder, wherein the sealant holder is slideably disposed around the shaft member and is adjacent to one of the one or more cylindrical sleeves;
compressing the sealant holder during the step of compressing the one or more cylindrical seals;
expelling the sealant from the sealant holder as the sealant holder compresses.

27. The method of claim 24, wherein the shaft member is hollow and wherein the expandable plug further comprises a pressure valve secured within the hollow shaft, the method further comprising:
opening the pressure valve before compressing the one or more cylindrical seals;
allowing a fluid in the tubular bore to flow through the pressure valve while compressing the one or more cylindrical seals.

28. The method of claim 27, further comprising:
determining the pressure within the tubular bore after sealing the tubular bore; and
adding additional fluid through the pressure valve to achieve a desired pressure within the tubular bore.

29. The method of claim 2, further comprising:
opening the pressure valve;
removing fluid through the pressure valve to achieve a desired pressure within the tubular bore.

30. A tool, comprising:
a handle;
a first threaded port on a first end of the handle;
a pin secured in a center of the threaded port, wherein the pin is parallel to a wall of the first threaded port;
a second port on a second end of the handle, wherein the first threaded port and the second port are in fluid communication.
